(19) United States
(12) Patent Application Publication
(10) Pub. No.: US 2009/0066106 A1
(43) Pub. Date: Mar. 12, 2009

(54) MULTIFUNCTIONAL COMPARTMENT FOR VEHICLES

(76) Inventor: Xian Ping LIU, Yulin (CN)

Correspondence Address: HAMRE, SCHUMANN, MUELLER & LARSON, P.C., P.O. BOX 2902, MINNEAPOLIS, MN, 55402-0902, US

(21) Appl. No.: 11/851,072

(22) Filed: Sep. 6, 2007

(51) Int. Cl. B60R 7/00

(52) U.S. Cl. 296/37.13

(57) ABSTRACT

A multifunctional compartment for vehicles comprises: a housing (1); and a door portion (2) movably connected with said housing; wherein a side plate (10) openable upwardly which is movably connected to said housing through a rod (100) driven by hydraulic pressure is defined under both sides of said housing; and tire shields (3) are arranged within said side plate which can be moved forward, backward, leftward or rightward for different frame girder, wheel span and wheel base. In accordance with the present invention, the compartment has good versatility to be used for various special vehicles and can be extended to achieve additional functions, for instance, advertising when loading goods.

### BACKGROUND OF THE INVENTION

1. Field of the Invention

The present invention relates to a multifunctional vehicle used for mobile command, rescue operation, office work, retail, catering trade, cleaning, advertisement, engineering, goods loading, traveling, emergency, etc., according to various requirements, more especially, to a multifunctional compartment which is applied thereon.

2. Description of the Prior Art

Currently there are many vehicles having certain special function which emhousing special devices with mobile communication, advertisement, exhibition, retail, engineering, or entertainment to serve as an emergency communication car, a motor vehicle equipped for collecting blood from donors, a vehicle displaying advertisements, and so on. These vehicles usually include a head and a compartment. The compartment is so designed as to achieve above-mentioned special functions. However, the specially designed compartment is only fit for single use and has poor versatility accordingly.

### BRIEF SUMMARY OF THE INVENTION

A primary object of the present invention is to provide a multifunctional compartment for vehicles which is available for various types of vehicles.

To achieve the above-mentioned object, a multifunctional compartment for vehicles comprises: a housing; and a door portion movably connected with said housing; wherein a side plate openable upwardly which is movably connected to said housing through a rod driven by hydraulic pressure is defined under both sides of said housing; and tire shields are arranged within said side plate which can be moved forward, backward, leftward or rightward for different frame girder, wheel span and wheel base.

In accordance with the present invention, the compartment has good versatility to be used for various special vehicles and can be extended to achieve additional functions, for instance, advertising when loading goods.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic side view of a multifunctional compartment in accordance with the present invention;

FIG. 2 is a schematic view showing a rear portion of the multifunctional compartment in accordance with the present invention;

FIG. 3 is another perspective view of the multifunctional compartment in accordance with the present invention;

FIG. 4 is another schematic side view of the multifunctional compartment in accordance with the present invention;

FIG. 5a is a schematic view showing a side opened outwardly; FIG. 5b is a schematic view showing a side opened uprightly; and

FIG. 6 is a schematic view showing a door movably connected with a housing by hinges.

### DETAILED DESCRIPTION OF THE INVENTION

A multifunctional compartment for vehicles can serve as a carriage for a mobile command vehicle, a mobile office unit, a mobile retail vehicle, a mobile engineer vehicle, a mobile exhibition vehicle, a touring car, an urban cleaning vehicle, an ambulance, a mobile catering car, a goods vehicle and so on, through equipped with corresponding devices according respective requirements. The special vehicle includes a power supply, a set of device for displaying images or videos and playing audio, a communication device, a data processing device, a satellite-positioning system, and a monitor.

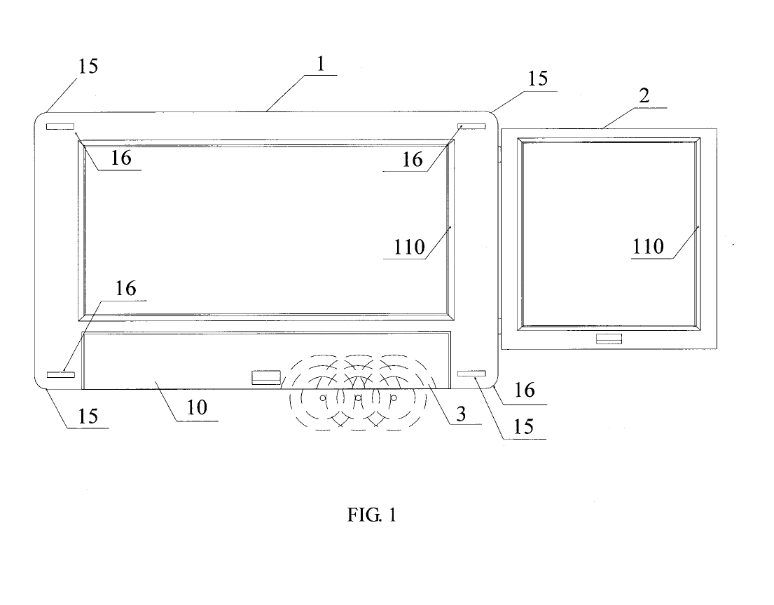

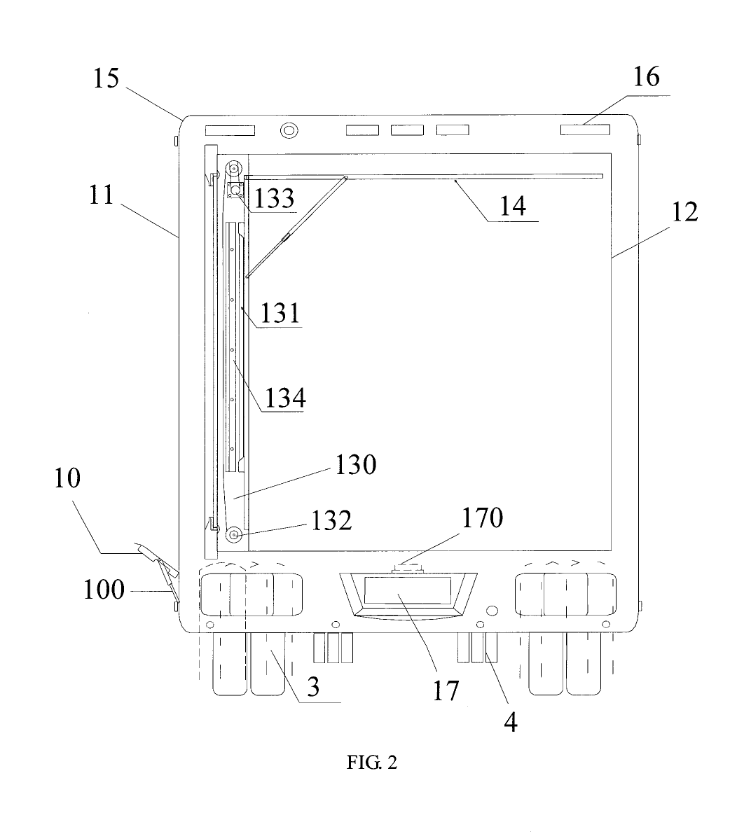

Referring to FIGS. 1-2, a multifunctional compartment for vehicles in accordance with a preferred embodiment of the present invention includes a housing 1 and a door portion 2.

Under both sides of the housing 1 there is a side plate 10 openable upwardly which is movably connected to the housing 1 through a rod 100 driven by hydraulic pressure. Tire shields 3 are arranged within the side plate 10 which can be moved forward or backward (seen from FIG. 1), and leftward or rightward (seen from FIG. 2), to be fit for different frame girders, wheel span and wheel base.

The housing 1 includes an external wall 11 and an internal housing 12. A thin case 13 is fixed between the external wall 11 and the internal housing 12. Within the thin case 13 there is a rollable panel 130 and a light system 131. A pair of scroll 132 is defined on both ends of the panel 130 for rolling up or winding down the panel 130 freely by manual operation or a motor 133. The panel 130 can be embedded with LEDs for displaying images or other materials (such as paper, fabric) suitable for showing information. The light system 131 is used for illuminating the panel 130, so that the panel 130 can still achieve display effect even though being in situation which is absence of light or in the night. To avoid displacement or swinging of the panel 130, a pressing strip 134 is formed on the panel 130. The panel 130 can be applied in different special vehicles to display advertising information without respective normal use. For instance, in a retail vehicle, the user can advertise his goods through the panel 130; or in a touring car, the user can make an introduction to the scenic areas and scenic spots on the panel 130.

The external wall 11 located outside of the thin case 13 is made of transparent materials such as glass and the glass is glazed outwardly with a mounting rubber 110, which makes people see the information displayed on the panel 130 from the outside of the compartment. A mounting rubber 110 has a bevel or rectangular cross section. Adopting the bevel or rectangular cross section has greatly improved the conventional glazing method and increase decorative effect of appearance yet. When the vehicle runs, a large centrifugal force created by the glass pushes the glass to tightly joint the mounting rubber 110 having a bevel or rectangular cross section, so as to achieve waterproof effect and increase stability.

An anticollision door 14 which can opened uprightly, leftward or rightward is defined adjacent to the thin case 13. The anticollision door 14 is also made of transparent materials. Benefits brought by the anticollision door 14 are as follows: 1. avoid the goods loaded colliding the panel 130; 2. be available to fix a light source thereon; 3. the panel 130 can be illuminated by a light source in the internal housing 12; 4. be available to fix an LED plate; 5. be convenient to repair the thin case 13.

In this embodiment the housing 1 is a rectangular body and each corner 15 is rounded angle. A width lamp 16 is formed in the corner 15 to mark the width of the compartment. The rounded angle changes the common square corner to create an smooth vision. When the vehicle runs, it can decrease the noise caused by the wind resistance.

An inlayed portion 17 is defined downwardly at the rear portion of the housing 1 for receiving a license plate or serves as a skidproof pedal. A light portion 170 is mounted above the inlayed portion 17 for illuminating the license plate and the skidproof pedal in darkness.

A frame is arranged under the housing 1 and is suitable for mounting two or three girders 4 according different types of vehicles.

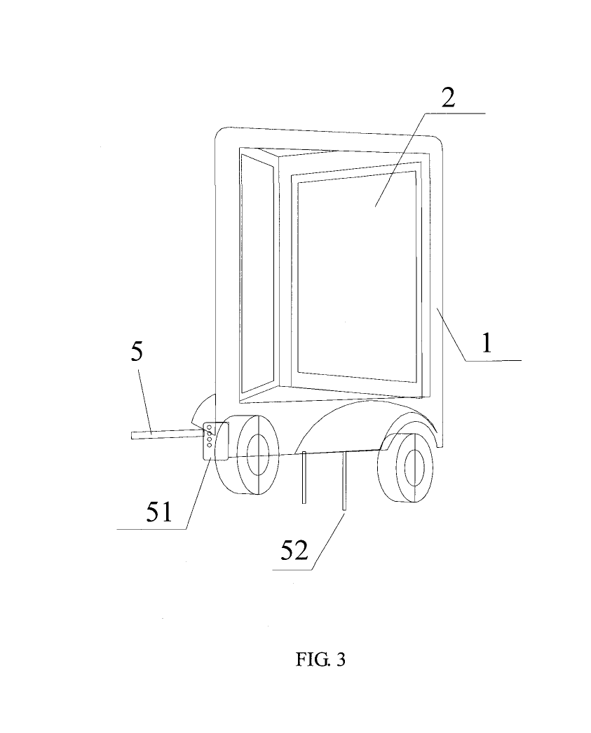

Referring to FIG. 3, the shape of the housing 1 is designed based on requirement. It can be a rectangular body, a triangle body (seen from FIG. 3) or a trapeziform body. A traction device is installed on the housing 1 and includes a telescopic arm 51 for pulling the compartment and a support leg 52 for parking the compartment.

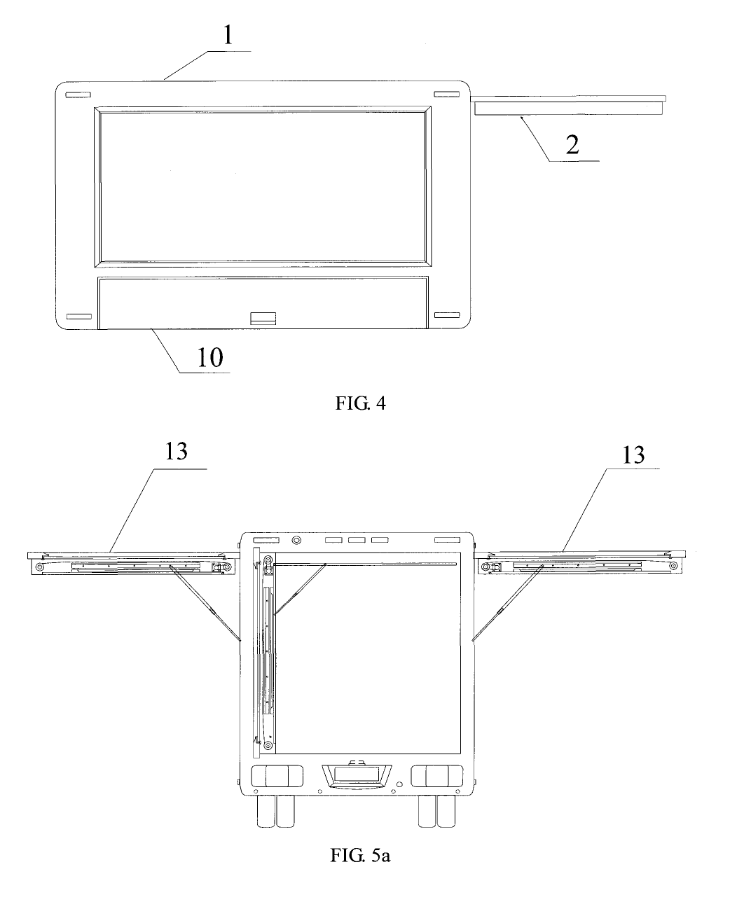

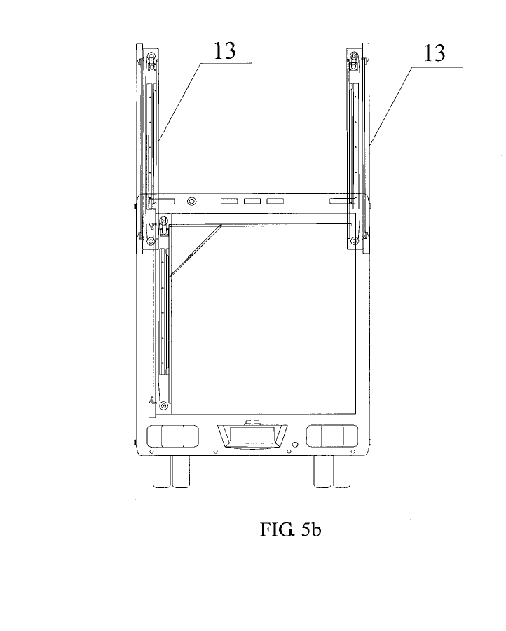

The door portion 2 is formed at the rear of the housing 1 and can be opened uprightly, leftward or rightward. FIG. 1 shows a situation of opening leftward and FIG. 4 shows a situation of opening uprightly. The door portion 2 is similar to the thin case 13 that includes the panel 130 and the light system 131, so detailed description is omitted here. It should be understood that in the embodiment the thin case 13 could be designed as the door portion 2 showing in FIG. 5 and through above-mentioned way could be opened outwardly (FIG. 5a) or uprightly (FIG. 5b).

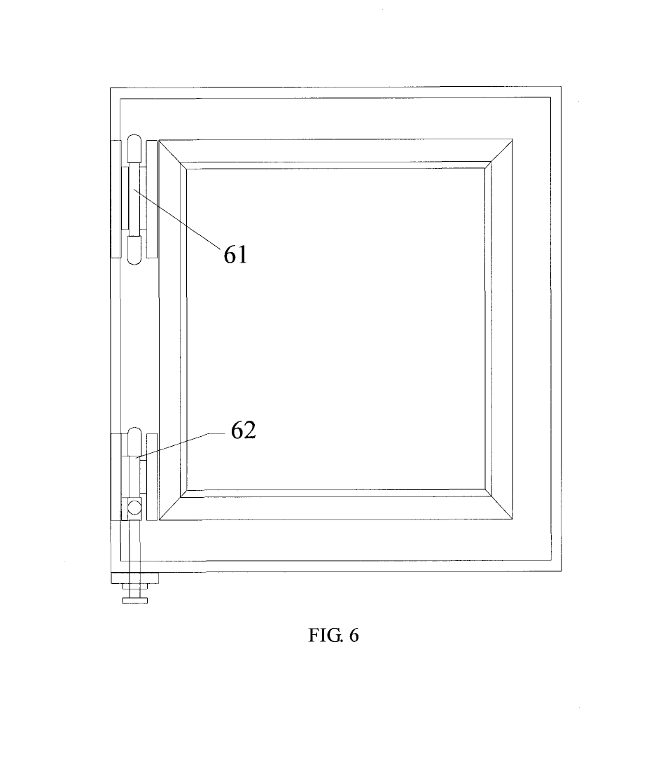

A preferred opening way of the door portion 2 is with aid of hydraulic pressure. One side of the door portion 2 is connected with the housing 1 by a hidden or exposed hinge. Set a first point on the housing 1 and a second point on the door portion 2, then connect the two points by hydraulic pressure device or other support device which is telescopic in certain length, so that the door portion 2 can be opened by an angle. Through changing the position of the points or the length of the support device to adjust the opening angle of the door portion 2. The hinge can prevent the door portion 2 from deforming because of its weight or long-time vibration and includes an upper hinge 61 and a lower hinge 62. Referring to FIG. 6, the upper hinge 61 and the lower hinge 62 have an identical axis and can turn the door portion 2 along the same angle. The lower hinge is used for supporting the weight of the door portion 2 and positioning the door portion 2 when turning, so as to avoid the door portion 2 from deforming to change the accurate position during long-time use.

It should be understood that the door portion 2 can be opened through pulley blocks or rigid bar having power unit.

In accordance with the present invention, the compartment has good versatility to be used for various special vehicles and can be extended to achieve additional functions, for instance, advertising when loading goods.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A multifunctional compartment for vehicles comprising:
a housing (1); and
a door portion (2) movably connected with said housing;
wherein a side plate (10) openable upwardly which is movably connected to said housing through a rod (100) driven by hydraulic pressure is defined under both sides of said housing; and tire shields (3) are arranged within said side plate which can be moved forward, backward, leftward or rightward for different frame girder, wheel span and wheel base.

2. The compartment as claimed in claim 1, wherein said housing includes an external wall (11) and an internal housing (12), and a thin case (13) is fixed between said external wall and said internal housing.

3. The compartment as claimed in claim 2, wherein a rollable panel (130) for displaying information and a light system (131) for providing illumination to said panel are respectively formed within said thin case.

4. The compartment as claimed in claim 3, wherein said panel is embedded with LEDs for displaying images or other materials suitable for showing information, and a pair of scroll (132) is defined on both ends of said panel for rolling up or winding down said panel freely by manual operation or a motor (133); and a pressing strip (134) is formed on said panel for avoiding displacement or swinging of said panel.

5. The compartment as claimed in claim 3, wherein said external wall located outside of said thin case is made of transparent materials and said transparent materials are glazed outwardly with a mounting rubber (110) for making people see the information displayed on said panel from the outside of the compartment; and said mounting rubber has a bevel or rectangular cross section.

6. The compartment as claimed in claim 3, wherein an anticollision door (14) which can opened uprightly, leftward or rightward is defined adjacent to said thin case, and said anticollision door is made of transparent materials.

7. The compartment as claimed in claim 1, wherein each corner (15) of said housing is rounded angle and a width lamp (16) is formed in said corner for marking the width of the compartment.

8. The compartment as claimed in claim 1, wherein an inlayed portion (17) is defined downwardly at the rear portion of said housing for receiving a license plate or serves as a skidproof pedal, and a light portion (170) is mounted above said inlayed portion for illuminating said license plate and said skidproof pedal in darkness.

9. The compartment as claimed in claim 1, wherein a frame is arranged under said housing and is suitable for mounting two or three girders (4) according different types of vehicles.

10. The compartment as claimed in claim 1, wherein said housing is designed as a rectangular body, a triangle body or a trapeziform body, and a traction device is installed on said housing which includes a telescopic arm (51) for pulling the compartment and a support leg (52) for parking the compartment.

11. The compartment as claimed in claim 1, wherein said door portion is formed at the rear of said housing and is openable uprightly, leftward or rightward.

12. The compartment as claimed in claim 1, wherein said door portion is movably connected with said housing by an upper hinge (61) and a lower hinge (62) both having an identical axis.
